(19) United States
(12) Patent Application Publication
(10) Pub. No.: US 2021/0081861 A1
(43) Pub. Date: Mar. 18, 2021

(54) METHODS, SYSTEMS, APPARATUSES, AND DEVICES FOR FACILITATING MANAGEMENT OF SERVICES FOR AN INDIVIDUAL AT AN EVENT

(71) Applicants: Cristin Renee Combs, Brandon, FL (US); Jason Eduardo Choate, Brandon, FL (US)

(72) Inventors: Cristin Renee Combs, Brandon, FL (US); Jason Eduardo Choate, Brandon, FL (US)

(21) Appl. No.: 17/020,138

(22) Filed: Sep. 14, 2020

Related U.S. Application Data
(60) Provisional application No. 62/900,070, filed on Sep. 13, 2019.

(51) Int. Cl. G06Q 10/06; G06Q 20/20

(52) U.S. Cl. CPC G06Q 10/06311; G06Q 20/202

(57) ABSTRACT

Disclosed herein is a method for facilitating management of services for an individual at an event, in accordance with some embodiments. Accordingly, the method may include a step of receiving, using a communication device, individual data from a individual device. Further, the method may include a step of retrieving, using a storage device, event data associated with an event. Further, the method may include a step of analyzing, using a processing device, the individual data based on the event data. Further, the method may include a step of determining, using the processing device, a time and a location associated with a service based on the analyzing. Further, the method may include a step of generating, using the processing device, service data based on the determining. Further, the method may include a step of transmitting, using the communication device, the service data to a service provider device.

The current application claims a priority to the U.S. Provisional Patent application Ser. No. 62/900,070 filed on Sep. 13, 2019. The current application is filed on Sep. 14, 2020 while Sep. 13, 2020 was on a weekend.

### FIELD OF THE INVENTION

Generally, the present disclosure relates to the field of data processing. More specifically, the present disclosure relates to methods, systems, apparatuses, and devices for facilitating management of services for an individual at an event

### BACKGROUND OF THE INVENTION

Stadiums and Arenas have only 3-4 event hours to provide service to their suite holders on a game or event day. Since suite attendants are taking orders manually. By the time the suite attendants make it to POS systems and place an order, 15 to 30 minutes can go by, as they are managing several suites in any given event day. Also, manual ordering is a thing of the past. The POS systems are only as fast as the people that are bringing that information to them. In a stadium and arena, it can take up to 10-15 minutes just to walk to where orders can be placed.

Existing techniques for facilitating management of services for an individual at an event are deficient with regard to several aspects. For instance, current technologies do not allow the individual to pre-order foods and beverages at a particular area in a stadium during the event.

Therefore, there is a need for improved methods, systems, apparatuses, and devices for facilitating management of services for an individual at an event that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method for facilitating management of services for an individual at an event, in accordance with some embodiments. Accordingly, the method may include a step of receiving, using a communication device, at least one individual data associated with at least one individual from at least one individual device. Further, the method may include a step of retrieving, using a storage device, at least one event data associated with at least one event. Further, the at least one event data may include a location of the at least one event and a time of the at least one event. Further, the method may include a step of analyzing, using a processing device, the at least one individual data based on the at least one event data. Further, the method may include a step of determining, using the processing device, at least one time and at least one location associated with at least one service based on the analyzing. Further, the method may include a step of generating, using the processing device, at least one service data based on the determining. Further, the method may include a step of transmitting, using the communication device, the at least one service data to at least one service provider device associated with at least one service provider. Further, the at least one service provider provides the at least one service to the at least one individual.

Further disclosed herein is a system for facilitating management of services for an individual at an event, in accordance with some embodiments. Accordingly, the system may include a communication device, a processing device, a storage device. Further, the communication device may be configured for receiving at least one individual data associated with at least one individual from at least one individual device. Further, the communication device may be configured for transmitting at least one service data to at least one service provider device associated with at least one service provider. Further, the at least one service provider provides the at least one service to the at least one individual. Further, the storage device may be configured for retrieving at least one event data associated with at least one event. Further, the at least one event data may include a location of the at least one event and a time of the at least one event. Further, the processing device may be communicatively coupled with the communication device and the storage device. Further, the processing device may be configured for analyzing the at least one individual data based on the at least one event data. Further, the processing device may be configured for determining at least one time and at least one location associated with at least one service based on the analyzing. Further, the processing device may be configured for generating at least one service data based on the determining.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a system for facilitating management of services for an individual at an event, in accordance with some embodiments.

FIG. 3 is a flowchart of a method for facilitating management of services for an individual at an event, in accordance with some embodiments.

FIG. 4 is a flowchart of a method for generating an alert for facilitating the management of the services for the individual at the event, in accordance with some embodiments.

FIG. 5 is a flowchart of a method for facilitating management of actions associated with the services, in accordance with some embodiments.

FIG. 6 is a flowchart of a method for facilitating tracking the services, in accordance with some embodiments.

FIG. 7 is a flowchart of a method for facilitating management of actions associated with the services for the individual by the individual, in accordance with some embodiments.

FIG. 8 is a flowchart of a method for facilitating management of orders associated with the services, in accordance with some embodiments.

FIG. 9 is a flowchart of a method for facilitating management of the services for the individual by identifying the individual, in accordance with some embodiments.

FIG. 10 is a flowchart of a method for facilitating management of the services for the individual by an attendant, in accordance with some embodiments.

FIG. 11 illustrates a user interface for an application on a device, in accordance with some embodiments.

FIG. 12 illustrates the user interface for the application on the device, in accordance with some embodiments.

FIG. 13 illustrates the user interface for the application on the device, in accordance with some embodiments.

FIG. 14 illustrates the user interface for the application on the device, in accordance with some embodiments.

FIG. 15 illustrates the user interface for the application on the device, in accordance with some embodiments.

FIG. 16 illustrates the user interface for the application on the device, in accordance with some embodiments.

FIG. 17 illustrates the user interface for the application on the device, in accordance with some embodiments.

FIG. 18 illustrates the user interface for the application on the device, in accordance with some embodiments.

FIG. 19 illustrates the user interface for the application on the device, in accordance with some embodiments.

FIG. 20 illustrates the user interface for the application on the device, in accordance with some embodiments.

FIG. 21 illustrates the user interface for the application on the device, in accordance with some embodiments.

FIG. 22 illustrates the user interface for the application on the device, in accordance with some embodiments.

FIG. 23 illustrates the user interface for the application on the device, in accordance with some embodiments.

FIG. 24 illustrates the user interface for the application on the device, in accordance with some embodiments.

FIG. 25 illustrates the user interface for the application on the device, in accordance with some embodiments.

FIG. 26 illustrates the user interface for the application on the device, in accordance with some embodiments.

FIG. 27 illustrates the user interface for the application on the device, in accordance with some embodiments.

FIG. 28 illustrates the user interface for the application on the device, in accordance with some embodiments.

FIG. 29 is a block diagram of a computing device for implementing the methods disclosed herein, in accordance with some embodiments.

FIG. 30 is an illustration of a user interface of an application, in accordance with some embodiments.

FIG. 31 is an illustration of the user interface of the application, in accordance with some embodiments.

FIG. 32 is an illustration of the user interface of the application, in accordance with some embodiments.

FIG. 33 is an illustration of the user interface of the application, in accordance with some embodiments.

FIG. 34 is an illustration of the user interface of the application, in accordance with some embodiments.

FIG. 35 is an illustration of the user interface of the application, in accordance with some embodiments.

FIG. 36 is an illustration of the user interface of the application, in accordance with some embodiments.

FIG. 37 is an illustration of the user interface of the application, in accordance with some embodiments.

FIG. 38 is an illustration of the user interface of the application, in accordance with some embodiments.

FIG. 39 is an illustration of the user interface of the application, in accordance with some embodiments.

FIG. 40 is an illustration of the user interface of the application, in accordance with some embodiments.

FIG. 41 is an illustration of the user interface of the application, in accordance with some embodiments.

FIG. 42 is an illustration of the user interface of the application, in accordance with some embodiments.

FIG. 43 is an illustration of the user interface of the application, in accordance with some embodiments.

FIG. 44 is an illustration of the user interface of the application, in accordance with some embodiments.

FIG. 45 is an illustration of the user interface of the application, in accordance with some embodiments.

FIG. 46 is an illustration of the user interface of the application, in accordance with some embodiments.

FIG. 47 is an illustration of the user interface of the application, in accordance with some embodiments.

FIG. 48 is an illustration of the user interface of the application, in accordance with some embodiments.

FIG. 49 is an illustration of the user interface of the application, in accordance with some embodiments.

FIG. 50 is an illustration of the user interface of the application, in accordance with some embodiments.

FIG. 51 is an illustration of the user interface of the application, in accordance with some embodiments.

FIG. 52 is an illustration of the user interface of the application, in accordance with some embodiments.

FIG. 53 is an illustration of the user interface of the application, in accordance with some embodiments.

FIG. 54 is an illustration of the user interface of the application, in accordance with some embodiments.

FIG. 55 is an illustration of the user interface of the application, in accordance with some embodiments.

FIG. 56 is an illustration of the user interface of the application, in accordance with some embodiments.

FIG. 57 is an illustration of the user interface of the application, in accordance with some embodiments.

FIG. 58 is an illustration of the user interface of the application, in accordance with some embodiments.

FIG. 59 is an illustration of the user interface of the application, in accordance with some embodiments.

FIG. 60 is an illustration of the user interface of the application, in accordance with some embodiments.

FIG. 61 is an illustration of the user interface of the application, in accordance with some embodiments.

FIG. 62 is a partial flow diagram of a method for facilitating managing, ordering, and accepting sales of food and beverage, in accordance with some embodiments.

FIG. 63 is a partial flow diagram of the method for facilitating the managing, the ordering, and the accepting sales of the food and the beverage, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, apparatuses, and devices for facilitating management of services for an individual at an event embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smartphone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice-based interface, gesture-based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third-party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role-based access control, and so on.

Further, one or more steps of the method disclosed herein may be initiated, maintained, controlled, and/or terminated based on a control input received from one or more devices operated by one or more users such as, for example, but not limited to, an end-user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human-readable secret data (e.g. username, password, passphrase, PIN, secret question, secret answer, etc.) and/or possession of a machine-readable secret data (e.g. encryption key, decryption key, bar codes, etc.) and/or or possession of one or more embodied characteristics unique to the user (e.g. biometric variables such as but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human-readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor, etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure describes methods, systems, apparatuses, and devices for facilitating management of services for an individual at an event. Further, the present disclosure describes a platform for the audiences, vendors, and management of the event to find a common ground. Further, the present disclosure describes allowing the members of an event to check-in, place an order, and manage the order through the app by using a smart device. Further, the present disclosure works particularly well with the audiences who have their suite. Further, the present disclosure describes allowing a user to communicate their orders of food and beverage items securely and conveniently. Further, the present disclosure presents a perfect solution for both suite owners and the kitchen staff.

Further, the present disclosure relates generally to a system for the point of sale in any area of the online ordering system. Further, the present disclosure provides a user with the ability to manage, order, and accept sales of food and beverage on any smart device running the ASAP Premium Service app.

Further, the present disclosure describes ASAP! Premium Service using which guests may no longer have to wait for their attendant upon arrival, they can place orders through the app, the cashier may receive a ticket for beverages as well as the kitchen for food orders. They can request their attendant for special requests. Admin tablets may be provided to management to track and monitor all orders in the building and address any billing issues by accessing the back end of their POS from the mobile device. Guests and attendants download and login to the app. Either as a guest or as an attendant. Both have the ability to electronically place orders through API integration work with the existing POS system to help expedite all orders for faster delivery time. ASAP! may be accessed either through a personal device from the app or if the client prefers, an install of a tablet may be mounted in each suite that may feature the app. All suite attendants may receive notifications on their personal devices. Further, the ASAP! can be used in any venue that has staff delivering food and beverage to any given area. Further, the area may be the Premium Service Areas.

Further, the present disclosure describes a Mobile Application that pride speed of service and payment system for food and beverage orders to premium service areas of stadiums and arenas. Further, the Mobile Application may be used for ordering food and beverage in premium service areas of stadiums and arenas.

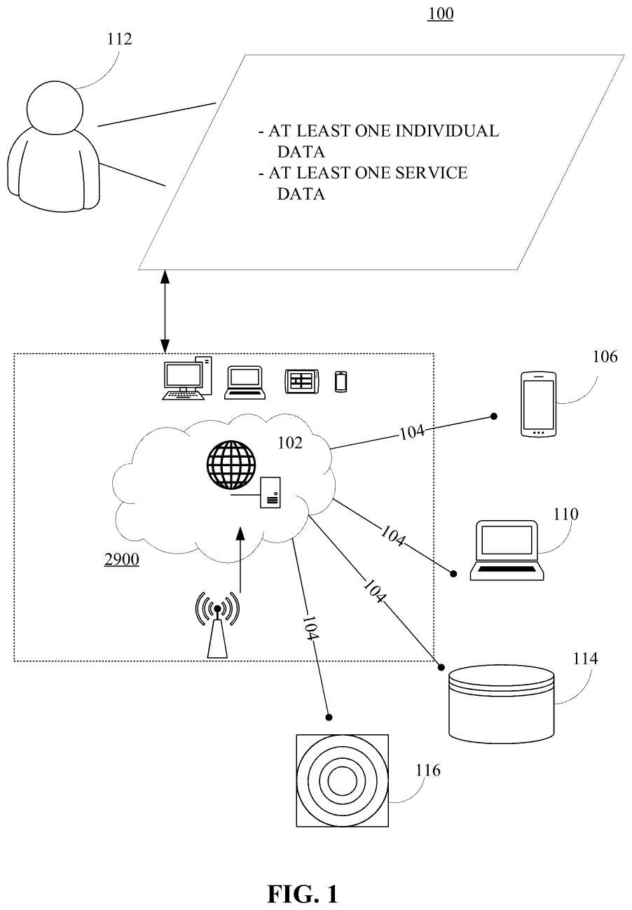

FIG. 1 is an illustration of an online platform 100 consistent with various embodiments of the present disclosure. By way of non-limiting example, the online platform 100 to facilitate management of services for an individual at an event may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, administrators, service providers, service consumers, individuals, and so on. Accordingly, in some instances, electronic devices operated by the one or more relevant parties may be in communication with the platform.

A user 112, such as the one or more relevant parties, may access online platform 100 through a web-based software application or browser. The web-based software application may be embodied as, for example, but not be limited to, a website, a web application, a desktop application, and a mobile application compatible with a computing device 2900.

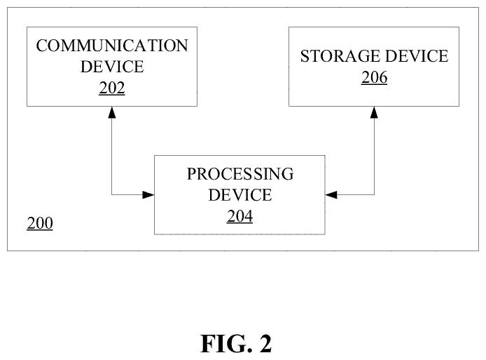

FIG. 2 is a block diagram of a system 200 for facilitating management of services for an individual at an event, in accordance with some embodiments. Further, the system 200 may include a communication device 202, a storage device 206, and a processing device 204.

Further, the communication device 202 may be configured for receiving at least one individual data associated with at least one individual (such as the user 112) from at least one individual device (such as the mobile device 106, the electronic devices 110, etc.). Further, the at least one individual may be an audience, a participant, a guest, etc. Further, the at least one individual data may include any information of the at least one individual. Further, the at least one individual device may include a computing device such as, but not limited to, a smartphone, a tablet, a smartwatch, a laptop, a desktop, and so on. Further, the at least one individual device may be at least one wearable device worn by the at least one individual. Further, the at least one individual device may be at least one portable device carried by the at least one individual. Further, the communication device 202 may be configured for transmitting at least one service data to at least one service provider device (such as the mobile device 106, the electronic devices 110, etc.) associated with at least one service provider (such as the user 112). Further, the at least one service provider device may include a computing device such as, but not limited to, a smartphone, a tablet, a smartwatch, a laptop, a desktop, and so on. Further, the at least one service provider provides the at least one service to the at least one individual.

Further, the storage device 206 may be configured for retrieving at least one event data associated with at least one event. Further, the at least one event data may include a location of the at least one event and a time of the at least one event. Further, the at least one event may include a seminar, a conference, a trade show, a workshop, a party, a gala, a sporting event, an entertainment event, etc. Further, the at least one event data may include any data associated with the at least one event. Further, the location of the at least one event may include a stadium, a theater, an amphitheater, an arena, a ring, etc. Further, the time of the at least one event may include at least one of a year, a month, a day, an hour, a minute, and a second.

Further, the processing device 204 may be communicatively coupled with the communication device 202 and the storage device 206. Further, the processing device 204 may be configured for analyzing the at least one individual data based on the at least one event data. Further, the at least one individual data may include at least one indication of the at least one event, at least one location indication of the at least one event, at least one time indication of the at least one event, etc. Further, the at least one individual data may include ticketing information, seating information, suite information, beverage information, food information, service information, etc. associated with the at least one event. Further, the processing device 204 may be configured for determining at least one time and at least one location associated with at least one service based on the analyzing. Further, the at least one service may include a food service, a beverage service, a seating service, a payment service, an escort service, a check-in service, etc. Further, the at least one location may include a seat, a suite, a platform, a stand, a premium area, an area, etc. associated with the location of the at least one event. Further, the at least one time may include at least one of a year, a month, a day, an hour, a minute, and a second associated with the time of the at least one event. Further, the processing device 204 may be configured for generating at least one service data based on the determining. Further, the at least one service data may be any data associated with the at least one service.

Further, in some embodiments, the at least one individual device may include at least one sensor (such as the sensors 116). Further, the at least one sensor may be configured for generating the at least one individual data based on a location of the at least one individual. Further, the at least one individual data may include a location information of the at least one individual. Further, the at least one sensor may be a location sensor. Further, the determining of the at least one time and the at least one location of the at least one service may be based on the analyzing.

Further, in an embodiment, the analyzing may include comparing the location of the at least one individual and the location of the at least one event based on the time of the at least one event. Further, the determining of the at least one time and the at least one location of the at least one service may be based on the comparing.

Further, in an embodiment, the communication device 202 may be configured for receiving at least one second sensor data from at least one second sensor (such as the sensors 116). Further, the at least one second sensor may be comprised in the at least one service provider device. Further, the at least one second sensor may be configured for generating the at least one second sensor data based on a location of the at least one service provider. Further, the at least one second sensor may be a location sensor. Further, the communication device 202 may be configured for transmitting at least one alert to at least one of the at least one individual device and the at least one service provider device. Further, the at least one of the at least one individual device and the at least one service provider device may be configured for presenting the at least one alert. Further, the at least one alert may include a vibrating alert, a sound alert, a light alert, etc. Further, the processing device 204 may be configured for analyzing the at least one second sensor data based on the at least one individual data. Further, the processing device 204 may be configured for determining a proximity between the at least one service provider and the at least one individual based on the analyzing of the at least one second sensor data. Further, the processing device 204 may be configured for generating the at least one alert based on the determining of the proximity. Further, the generating of the at least one alert may be associated with at least one frequency based on the proximity. Further, the at least one frequency of the at least one alert may increase based on an increase in the proximity. Further, the at least one frequency of the at least one alert may decrease based on a decrease in the proximity.

Further, in some embodiments, the communication device 202 may be configured for receiving at least one action data associated with the at least one service from the at least one service provider device. Further, the at least one action data may include at least one action performed by the at least one service provider for providing the at least one service to the at least one individual. Further, the at least one action may include any actions that may be required for providing the at least one service. Further, the at least one action associated with the food service may include a food preparing action, a food transporting action, a food presenting action, a food clearing action, etc. Further, the processing device 204 may be configured for analyzing the at least one action data based on the at least one event data. Further, the at least one event data may include a begin time of the at least one event, an end time of the at least one event, at least one recess time of the at least one event, etc. Further, the at least one event data may include a location and a time of at least one attraction in the at least one event. Further, the at least one attraction may be a sub-event within the at least one event. Further, the processing device 204 may be configured for determining at least one of a location and a time for performing the at least one action based on the analyzing of the at least one action data. Further, the generating of the at least one service data may be based on the determining of the at least one of the location and the time for performing the at least one action.

Further, in some embodiments, the communication device 202 may be configured for receiving at least one data associated with the at least one service from the at least one service provider device. Further, the communication device 202 may be configured for transmitting at least one status data to the at least one individual device. Further, the processing device 204 may be configured for analyzing the at least one data based on the at least one event data. Further, the processing device 204 may be configured for determining at least one status of the at least one service based on the analyzing of the at least one data. Further, the processing device 204 may be configured for generating the at least one status data associated with the at least one service based on the determining of the at least one status.

Further, in some embodiments, the communication device 202 may be configured for receiving at least one service indication associated with the at least one service from the at least one individual device. Further, the at least one service indication may indicate the at least one individual may want the at least one service. Further, the processing device 204 may be configured for analyzing the at least one service indication. Further, the processing device 204 may be configured for determining at least one action associated with the at least one service based on the analyzing of the at least one service indication. Further, the generating of the at least one service data may be based on the determining of the at least one action.

Further, in some embodiments, the communication device 202 may be configured for receiving at least one first data from the at least one service provider device. Further, the at least one first data may include the at least one service provided by the at least one service provider at the at least one event. Further, the at least one first data may include a menu associated with the at least one service provider. Further, the menu may include a list of services provided by the at least one service provider. Additionally, in some embodiments, the menu may include one or more QR codes corresponding to one or more menu items comprised in the menu for traceability and/or tracking purposes. Accordingly, in some instances, a QR code of a menu item may be scanned throughout a preparation and delivery process corresponding to the menu item. As a result, if anyone gets sick, the client may know exactly who touched what items and when, with a day and a time stamp. Further, the use of the one or more QR codes may also prevent theft and help with inventory management.

Further, the communication device 202 may be configured for transmitting at least one order to the at least one service provider device. Further, the processing device 204 may be configured for analyzing the at least one first data based on the at least one individual data. Further, the processing device 204 may be configured for generating at least one order associated with the at least one individual based on the analyzing. Further, the at least one order may include a selection of a number of services from the menu. Further, the at least one service may include the at least one order.

Further, in some embodiments, the communication device 202 may be configured for receiving at least one first sensor data from at least one first sensor (such as the sensors 116). Further, the at least one first sensor may be configured for generating the at least one first sensor data based on a presence of the at least one individual in the location of the at least one event at the time of the at least one event. Further, the processing device 204 may be configured for analyzing the at least one first sensor data. Further, the processing device 204 may be configured for identifying the at least one individual based on the analyzing of the at least one first sensor data. Further, the determining of the at least one time and the at least one location associated with the at least one service based on the analyzing of the at least one individual information may be based on the identifying.

Further, in some embodiments, the communication device 202 may be configured for receiving at least one individual indication associated with the at least one individual from at least one attendant device (such as the mobile device 106, the electronic devices 110, etc.). associated with at least one attendant (such as the user 112). Further, the at least one attendant device may be a computing device such as, but not limited to, a smartphone, a tablet, a smartwatch, a laptop, a desktop, etc. Further, the communication device 202 may be configured for receiving at least one second data from the at least one attendant device. Further, the processing device 204 may be configured for identifying the at least one individual based on the at least one individual indication. Further, the processing device 204 may be configured for modifying the at least one individual data based on the at least one second data. Further, the modifying may include adding the at least one service in the at least one individual data. Further, the analyzing the at least one individual data based on the at least one event data may be based on the modifying.

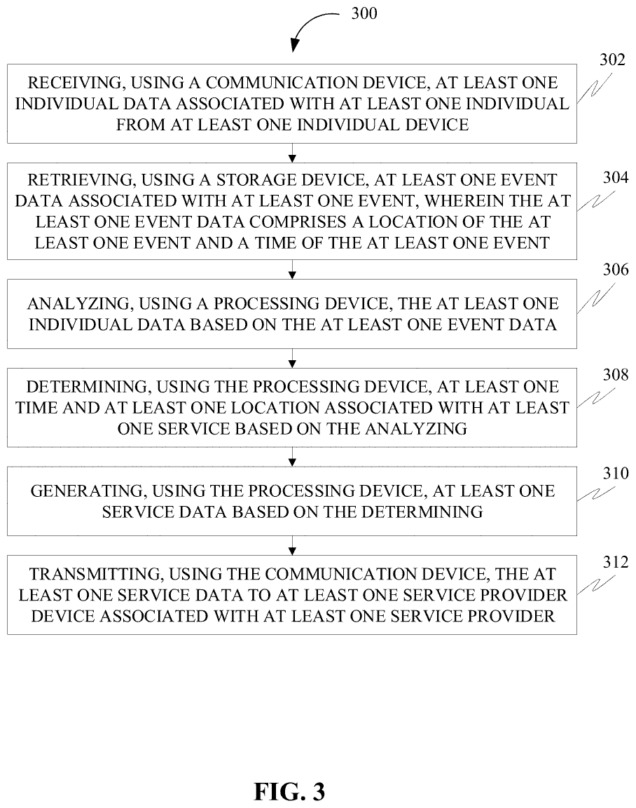

FIG. 3 is a flowchart of a method 300 for facilitating management of services for an individual at an event, in accordance with some embodiments. Further, at 302, the method 300 may include a step of receiving, using a communication device (such as the communication device 202), at least one individual data associated with at least one individual from at least one individual device.

Further, at 304, the method 300 may include a step of retrieving, using a storage device (such as the storage device 206), at least one event data associated with at least one event. Further, the at least one event data may include a location of the at least one event and a time of the at least one event.

Further, at 306, the method 300 may include a step of analyzing, using a processing device (such as the processing device 204), the at least one individual data based on the at least one event data.

Further, at 308, the method 300 may include a step of determining, using the processing device, at least one time and at least one location associated with at least one service based on the analyzing.

Further, at 310, the method 300 may include a step of generating, using the processing device, at least one service data based on the determining.

Further, at 312, the method 300 may include a step of transmitting, using the communication device, the at least one service data to at least one service provider device associated with at least one service provider. Further, the at least one service provider provides the at least one service to the at least one individual.

Further, in some embodiments, the at least one individual device may include at least one sensor. Further, the at least one sensor may be configured for generating the at least one individual data based on a location of the at least one individual. Further, the determining of the at least one time and the at least one location of the at least one service may be based on the analyzing. Further, in an embodiment, the analyzing may include comparing the location of the at least one individual and the location of the at least one event based on the time of the at least one event. Further, the determining of the at least one time and the at least one location of the at least one service may be based on the comparing.

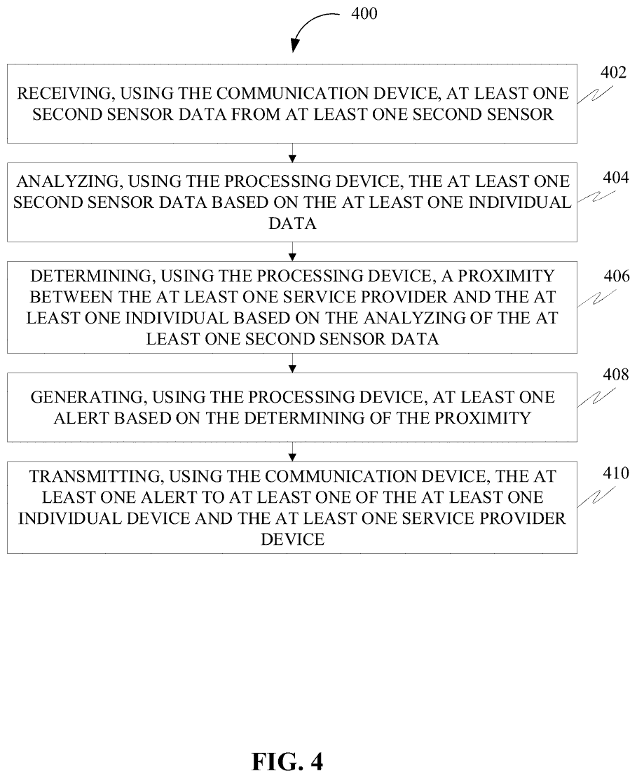

FIG. 4 is a flowchart of a method 400 for generating an alert for facilitating the management of the services for the individual at the event, in accordance with some embodiments. Further, at 402, the method 400 may include a step of receiving, using the communication device, at least one second sensor data from at least one second sensor. Further, the at least one second sensor may be comprised in the at least one service provider device. Further, the at least one second sensor may be configured for generating the at least one second data based on a location of the at least one service provider.

Further, at 404, the method 400 may include a step of analyzing, using the processing device, the at least one second sensor data based on the at least one individual data.

Further, at 406, the method 400 may include a step of determining, using the processing device, a proximity between the at least one service provider and the at least one individual.

Further, at 408, the method 400 may include a step of generating, using the processing device, at least one alert based on the determining.

Further, at 410, the method 400 may include a step of transmitting, using the communication device, the at least one alert to at least one of the at least one individual device and the at least one service provider device.

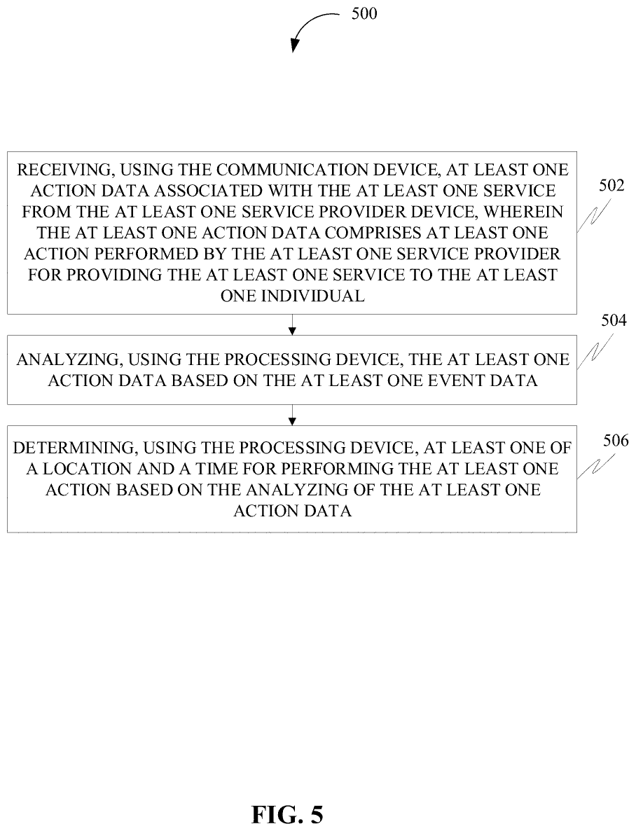

FIG. 5 is a flowchart of a method 500 for facilitating management of actions associated with the services, in accordance with some embodiments. Further, at 502, the method 500 may include a step of receiving, using the communication device, at least one action data associated with the at least one service from the at least one service provider device. Further, the at least one action data may include at least one action performed by the at least one service provider for providing the at least one service to the at least one individual.

Further, at 504, the method 500 may include a step of analyzing, using the processing device, the at least one action data based on the at least one event data; and

Further, at 506, the method 500 may include a step of determining, using the processing device, at least one of a location and a time for performing the at least one action based on the analyzing of the at least one action data. Further, the generating of the at least one service data may be based on the determining of the at least one of the location and the time for performing the at least one action.

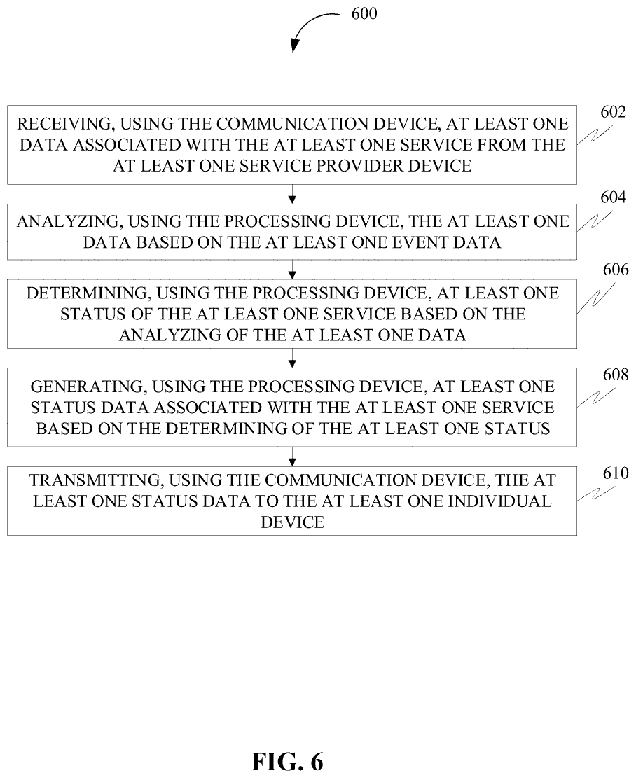

FIG. 6 is a flowchart of a method 600 for facilitating tracking the services, in accordance with some embodiments. Further, at 602, the method 600 may include a step of receiving, using the communication device, at least one data associated with the at least one service from the at least one service provider device.

Further, at 604, the method 600 may include a step of analyzing, using the processing device, the at least one data based on the at least one event data.

Further, at 606, the method 600 may include a step of determining, using the processing device, at least one status of the at least one service based on the analyzing of the at least one data.

Further, at 608, the method 600 may include a step of generating, using the processing device, at least one status data associated with the at least one service based on the determining of the at least one status.

Further, at 610, the method 600 may include a step of transmitting, using the communication device, the at least one status data to the at least one individual device.

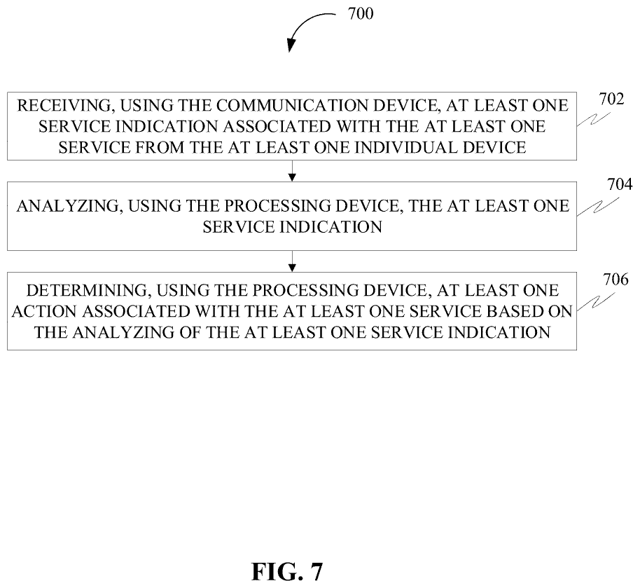

FIG. 7 is a flowchart of a method 700 for facilitating management of actions associated with the services for the individual by the individual, in accordance with some embodiments. Further, at 702, the method 700 may include a step of receiving, using the communication device, at least one service indication associated with the at least one service from the at least one individual device.

Further, at 704, the method 700 may include a step of analyzing, using the processing device, the at least one service indication.

Further, at 706, the method 700 may include a step of determining, using the processing device, at least one action associated with the at least one service based on the analyzing of the at least one service indication. Further, the generating of the at least one service data may be based on the determining of the at least one action

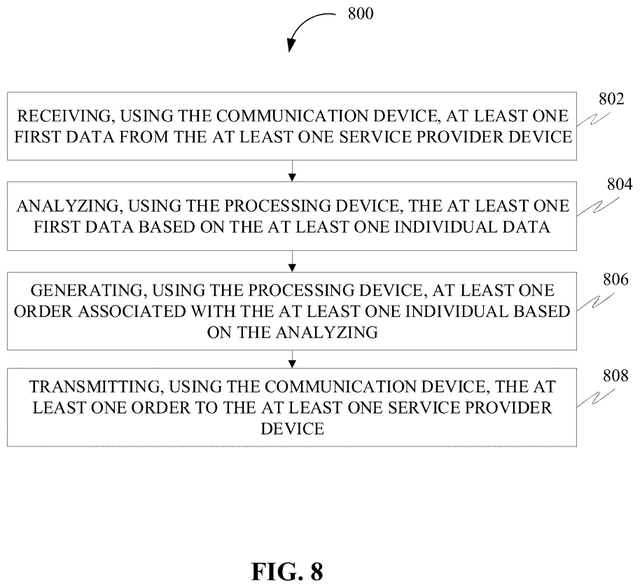

FIG. 8 is a flowchart of a method 800 for facilitating management of orders associated with the services, in accordance with some embodiments. Further, at 802, the method 800 may include a step of receiving, using the communication device, at least one first data from the at least one service provider device. Further, the at least one first data may include the at least one service provided by the at least one service provider at the at least one event.

Further, at 804, the method 800 may include a step of analyzing, using the processing device, the at least one first data based on the at least one individual data.

Further, at 806, the method 800 may include a step of generating, using the processing device, at least one order associated with the at least one individual based on the analyzing. Further, the at least one service may include the at least one order.

Further, at 808, the method 800 may include a step of transmitting, using the communication device, the at least one order to the at least one service provider device.

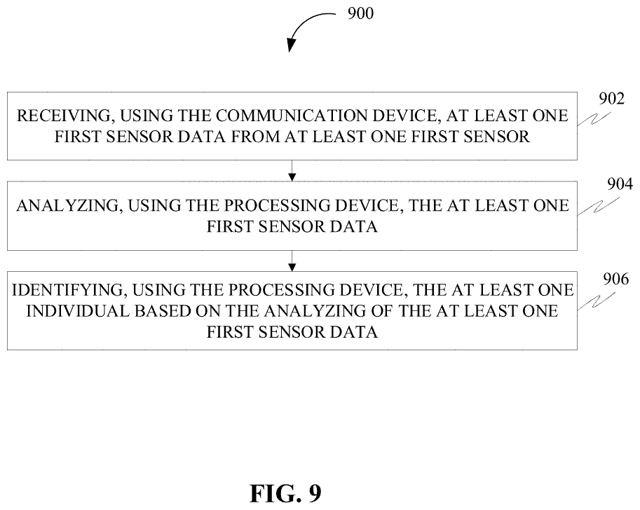

FIG. 9 is a flowchart of a method 900 for facilitating management of the services for the individual by identifying the individual, in accordance with some embodiments. Further, at 902, the method 900 may include a step of receiving, using the communication device, at least one first sensor data from at least one first sensor. Further, the at least one first sensor may be configured for generating the at least one first sensor data based on a presence of the at least one individual in the location of the at least one event at the time of the at least one event.

Further, at 904, the method 900 may include a step of analyzing, using the processing device, the at least one first sensor data.

Further, at 906, the method 900 may include a step of identifying, using the processing device, the at least one individual based on the analyzing of the at least one first sensor data. Further, the determining of the at least one time and the at least one location associated with the at least one service based on the analyzing of the at least one individual information may be based on the identifying.

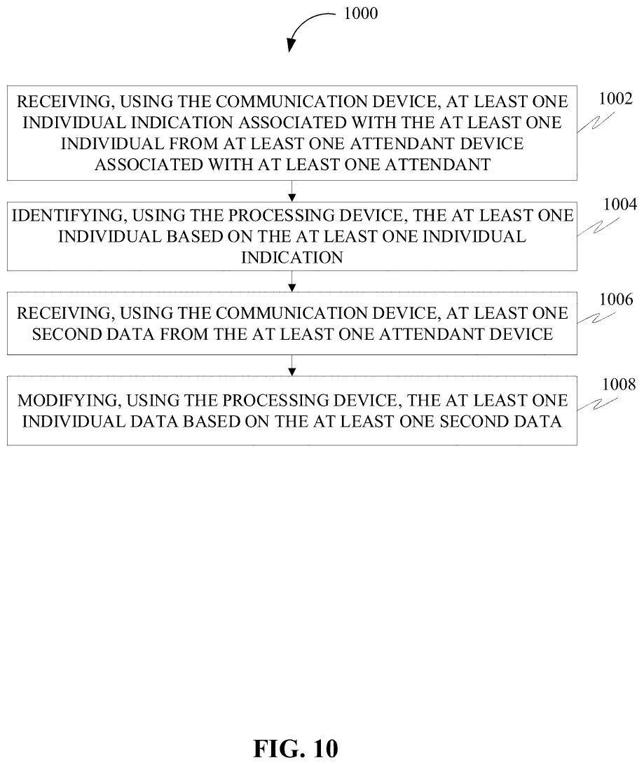

FIG. 10 is a flowchart of a method 1000 for facilitating management of the services for the individual by an attendant, in accordance with some embodiments. Further, at 1002, the method 1000 may include a step of receiving, using the communication device, at least one individual indication associated with the at least one individual from at least one attendant device associated with at least one attendant.

Further, at 1004, the method 1000 may include a step of identifying, using the processing device, the at least one individual based on the at least one individual indication;

Further, at 1006, the method 1000 may include a step of receiving, using the communication device, at least one second data from the at least one attendant device; and

Further, at 1008, the method 1000 may include a step of modifying, using the processing device, the at least one individual data based on the at least one second data. Further, the analyzing the at least one individual data based on the at least one event data may be based on the modifying.

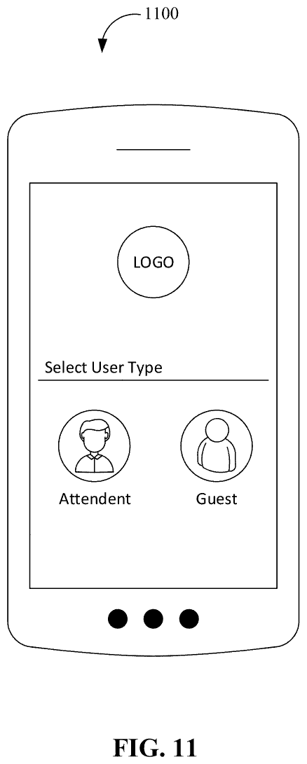

FIG. 11 illustrates a user interface for an application on a device 1100, in accordance with some embodiments. Further, the user interface may include a select user type of the application. Further, the application may be an “ASAP! Premium service”. Further, the device 1100 may include a handheld device, a portable device, a wearable device, etc. Further, the device 1100 may include a computing device such as a smartphone, a tablet, a smartwatch, a laptop, a desktop, and so on.

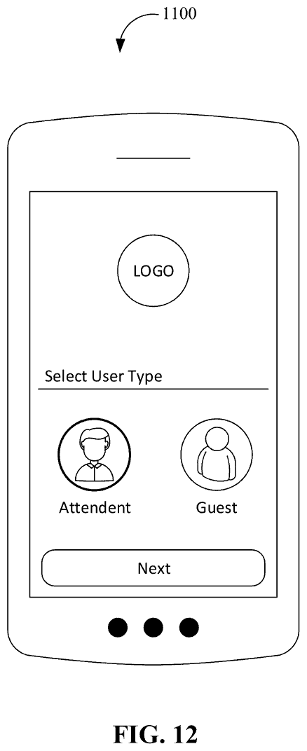

FIG. 12 illustrates the user interface for the application on the device 1100, in accordance with some embodiments. Further, the user interface may include the select user type screen of the application.

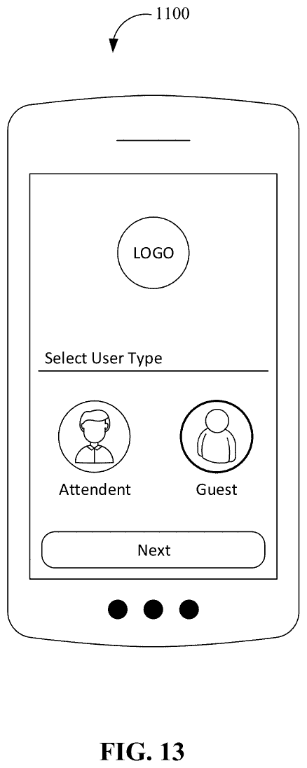

FIG. 13 illustrates the user interface for the application on the device 1100, in accordance with some embodiments. Further, the user interface may include the select user type screen of the application.

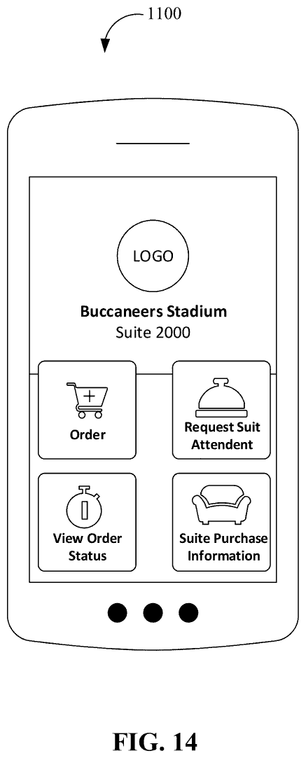

FIG. 14 illustrates the user interface for the application on the device 1100, in accordance with some embodiments. Further, the user interface may include a Buccaneers stadium suite 2000 screen of the application.

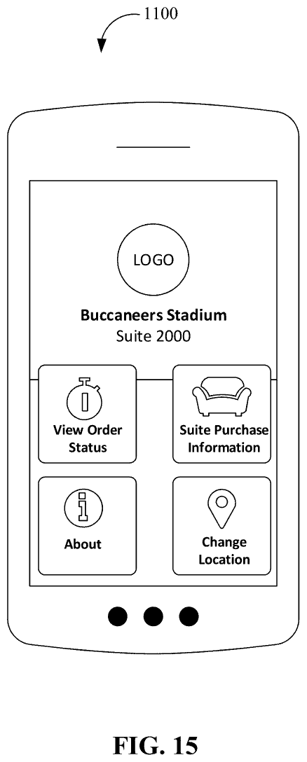

FIG. 15 illustrates the user interface for the application on the device 1100, in accordance with some embodiments. Further, the user interface may include the Buccaneers stadium suite 2000 screen of the application.

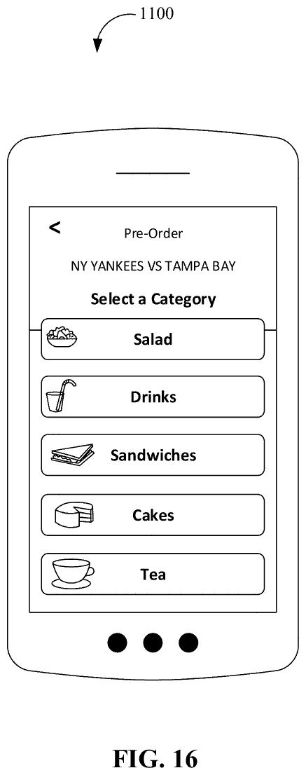

FIG. 16 illustrates the user interface for the application on the device 1100, in accordance with some embodiments. Further, the user interface may include a pre-order screen of the application.

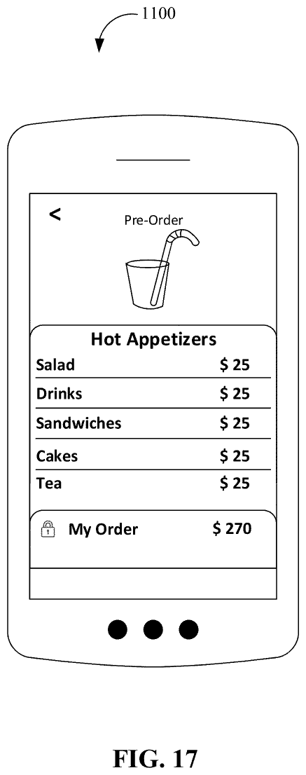

FIG. 17 illustrates the user interface for the application on the device 1100, in accordance with some embodiments. Further, the user interface may include the pre-order screen of the application.

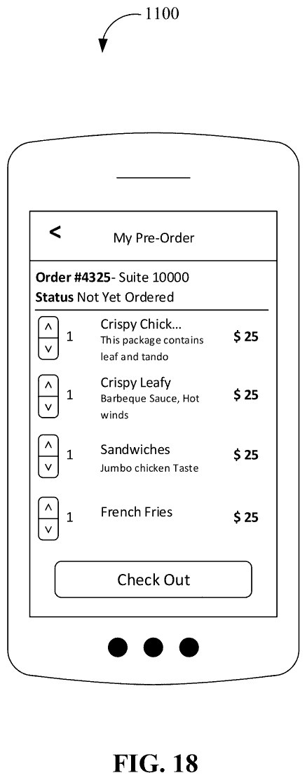

FIG. 18 illustrates the user interface for the application on the device 1100, in accordance with some embodiments. Further, the user interface may include a my pre-order screen of the application.

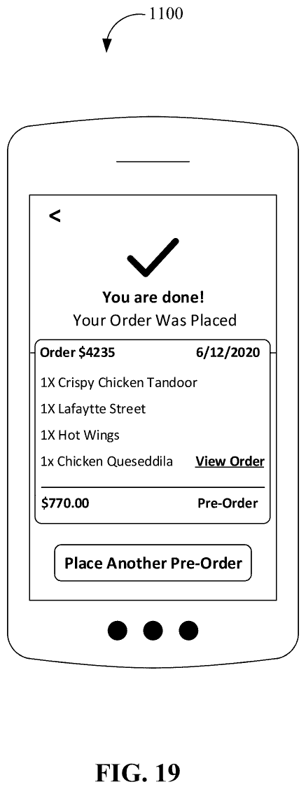

FIG. 19 illustrates the user interface for the application on the device 1100, in accordance with some embodiments. Further, the user interface may include a confirmation of an order screen of the application.

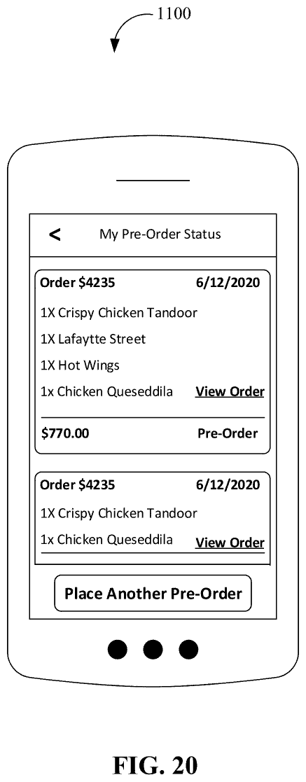

FIG. 20 illustrates the user interface for the application on the device 1100, in accordance with some embodiments. Further, the user interface may include a my pre-order status screen of the application.

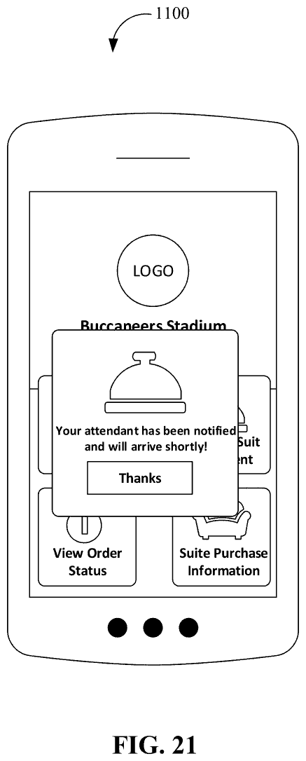

FIG. 21 illustrates the user interface for the application on the device 1100, in accordance with some embodiments. Further, the user interface may include a notification for an attendant screen of the application.

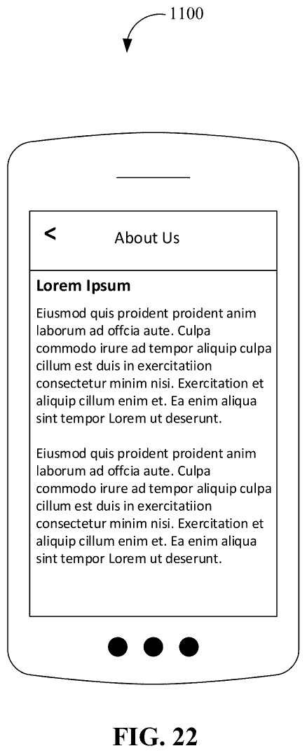

FIG. 22 illustrates the user interface for the application on the device 1100, in accordance with some embodiments. Further, the user interface may include an about us screen of the application.

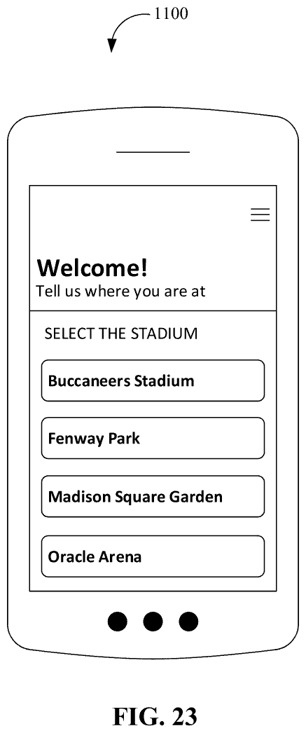

FIG. 23 illustrates the user interface for the application on the device 1100, in accordance with some embodiments. Further, the user interface may include a select the stadium screen of the application.

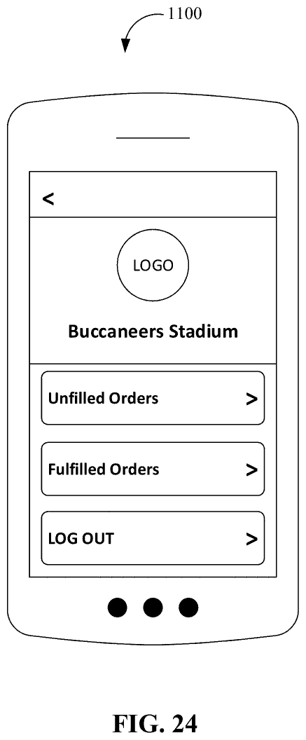

FIG. 24 illustrates the user interface for the application on the device 1100, in accordance with some embodiments. Further, the user interface may include a Buccaneers stadium screen of the application.

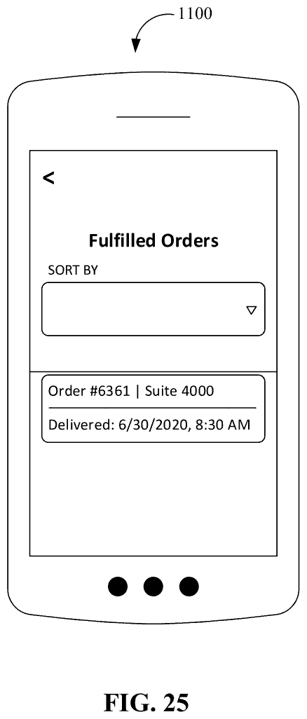

FIG. 25 illustrates the user interface for the application on the device 1100, in accordance with some embodiments. Further, the user interface may include a fulfilled order screen of the application.

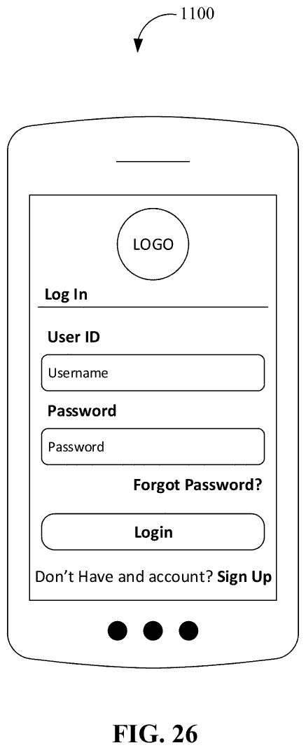

FIG. 26 illustrates the user interface for the application on the device 1100, in accordance with some embodiments. Further, the user interface may include a login screen of the application.

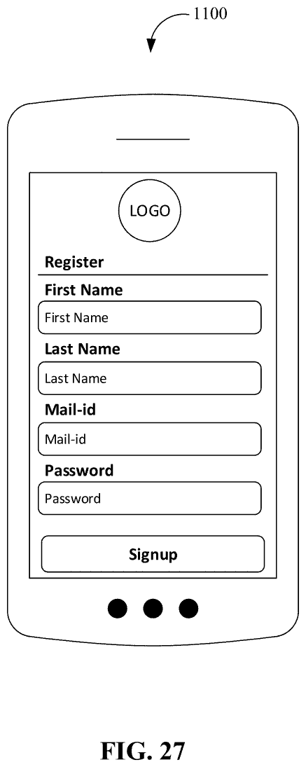

FIG. 27 illustrates the user interface for the application on the device 1100, in accordance with some embodiments. Further, the user interface may include a register screen of the application.

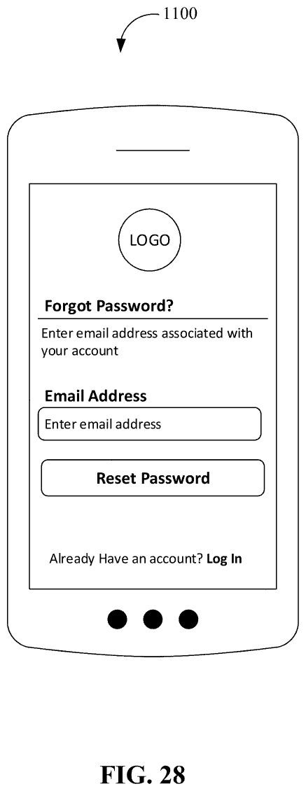

FIG. 28 illustrates the user interface for the application on the device 1100, in accordance with some embodiments. Further, the user interface may include a forgot password screen of the application.

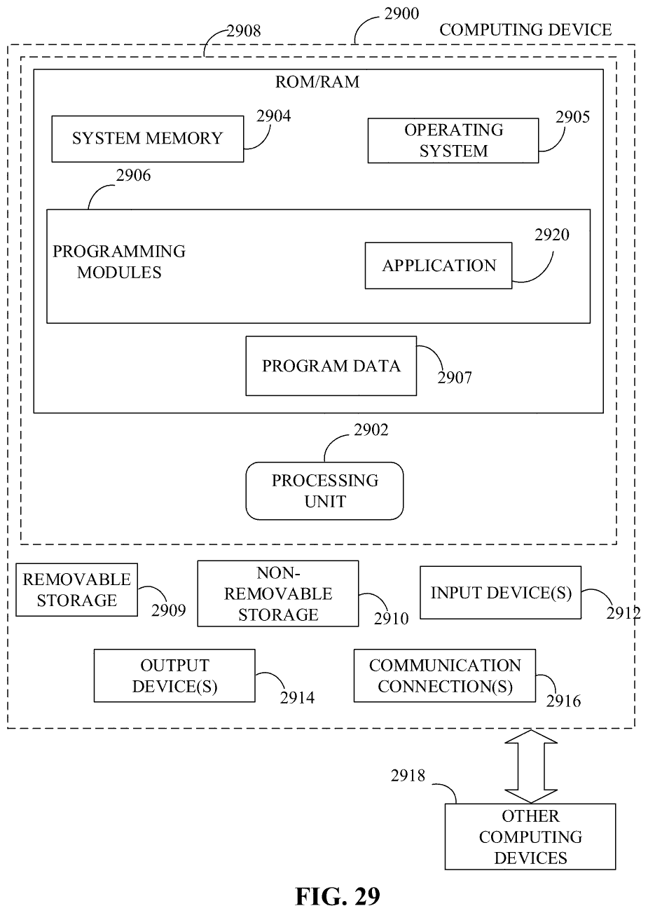

With reference to FIG. 29, a system consistent with an embodiment of the disclosure may include a computing device or cloud service, such as computing device 2900. In a basic configuration, computing device 2900 may include at least one processing unit 2902 and a system memory 2904. Depending on the configuration and type of computing device, system memory 2904 may comprise, but is not limited to, volatile (e.g. random-access memory (RAM)), non-volatile (e.g. read-only memory (ROM)), flash memory, or any combination. System memory 2904 may include operating system 2905, one or more programming modules 2906, and may include a program data 2907. Operating system 2905, for example, may be suitable for controlling computing device 2900's operation. In one embodiment, programming modules 2906 may include an image-processing module, a machine learning module. Furthermore, embodiments of the disclosure may be practiced in conjunction with a graphics library, other operating systems, or any other application program and is not limited to any particular application or system. This basic configuration is illustrated in FIG. 29 by those components within a dashed line 2908.

Computing device 2900 may have additional features or functionality. For example, computing device 2900 may also include additional data storage devices (removable and/or non-removable) such as, for example, magnetic disks, optical disks, or tape. Such additional storage is illustrated in FIG. 29 by a removable storage 2909 and a non-removable storage 2910. Computer storage media may include volatile and non-volatile, removable and non-removable media implemented in any method or technology for storage of information, such as computer-readable instructions, data structures, program modules, or other data. System memory 2904, removable storage 2909, and non-removable storage 2910 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2900. Any such computer storage media may be part of device 2900. Computing device 2900 may also have input device(s) 2912 such as a keyboard, a mouse, a pen, a sound input device, a touch input device, a location sensor, a camera, a biometric sensor, etc. Output device(s) 2914 such as a display, speakers, a printer, etc. may also be included. The aforementioned devices are examples and others may be used.

Computing device 2900 may also contain a communication connection 2916 that may allow device 2900 to communicate with other computing devices 2918, such as over a network in a distributed computing environment, for example, an intranet or the Internet. Communication connection 2916 is one example of communication media. Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein may include both storage media and communication media.

As stated above, a number of program modules and data files may be stored in system memory 2904, including operating system 2905. While executing on processing unit 2902, programming modules 2906 may perform processes including, for example, one or more stages of methods, algorithms, systems, applications, servers, databases as described above. The aforementioned process is an example, and processing unit 2902 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general-purpose graphics processor-based systems, multiprocessor systems, microprocessor-based or programmable consumer electronics, application-specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid-state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

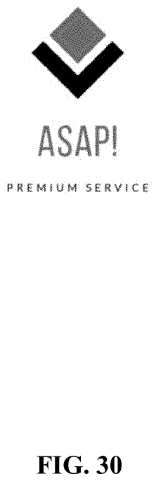

FIG. 30 is an illustration of a user interface of an application, in accordance with some embodiments. Further, the user interface may include a home screen of the application. Further, the application may be an “ASAP! Premium service”.

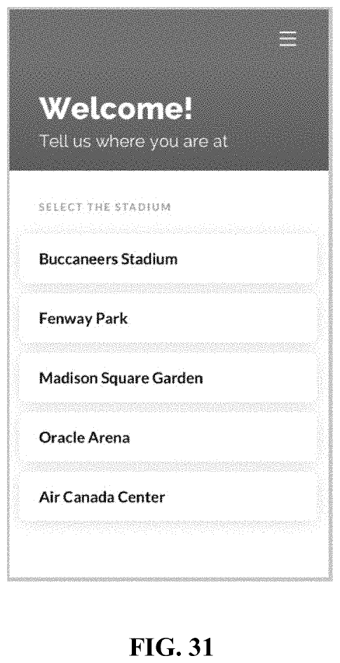

FIG. 31 is an illustration of the user interface of the application, in accordance with some embodiments. Further, the user interface may include a select the stadium screen of the “ASAP! Premium service”.

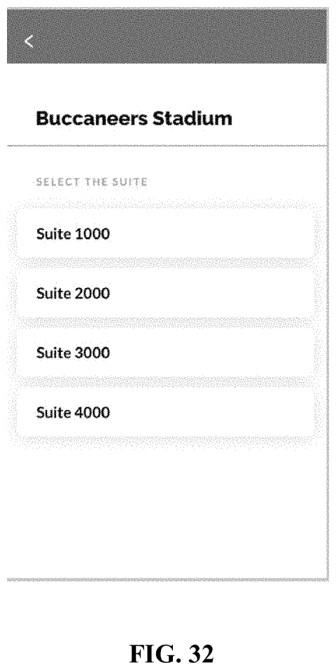

FIG. 32 is an illustration of the user interface of the application, in accordance with some embodiments. Further, the user interface may include a select the suite screen of the “ASAP! Premium service”.

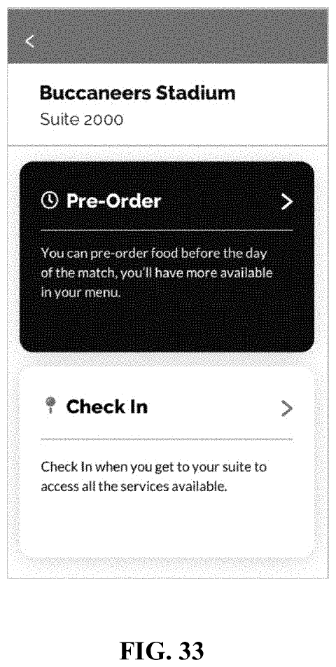

FIG. 33 is an illustration of the user interface of the application, in accordance with some embodiments. Further, the user interface may include a pre-order and a check-in screen of the “ASAP! Premium service”.

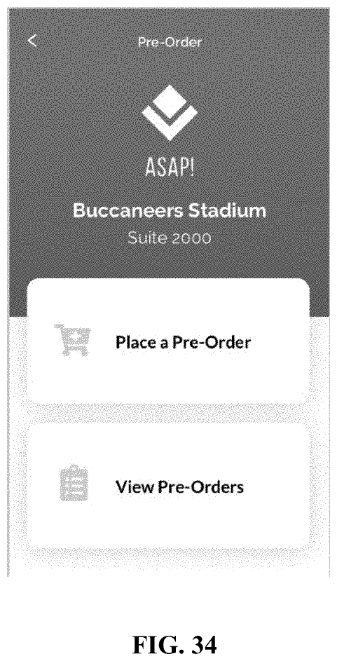

FIG. 34 is an illustration of the user interface of the application, in accordance with some embodiments. Further, the user interface may include a pre-order screen of the “ASAP! Premium service”.

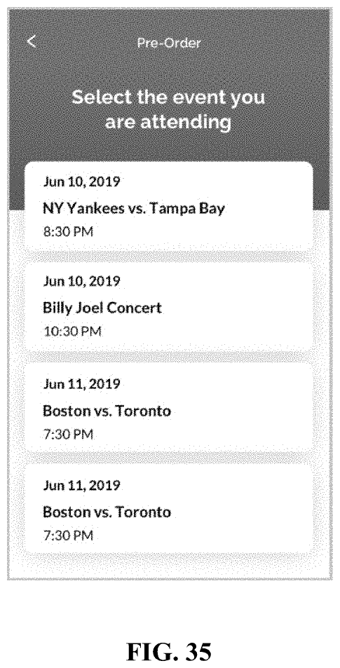

FIG. 35 is an illustration of the user interface of the application, in accordance with some embodiments. Further, the user interface may include the pre-order screen of the “ASAP! Premium service”.

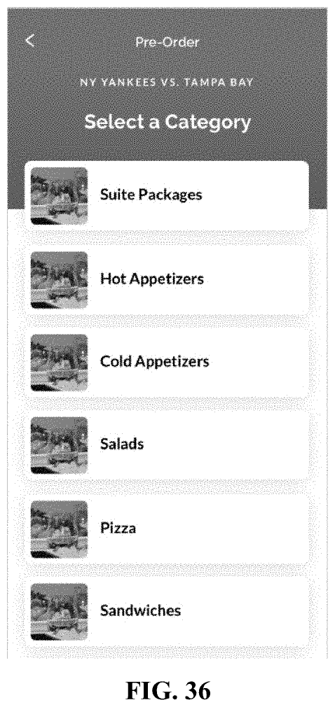

FIG. 36 is an illustration of the user interface of the application, in accordance with some embodiments. Further, the user interface may include the pre-order screen of the “ASAP! Premium service”.

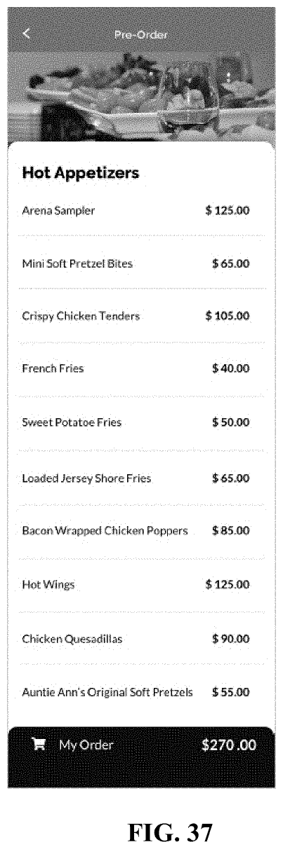

FIG. 37 is an illustration of the user interface of the application, in accordance with some embodiments. Further, the user interface may include the pre-order screen of the “ASAP! Premium service”.

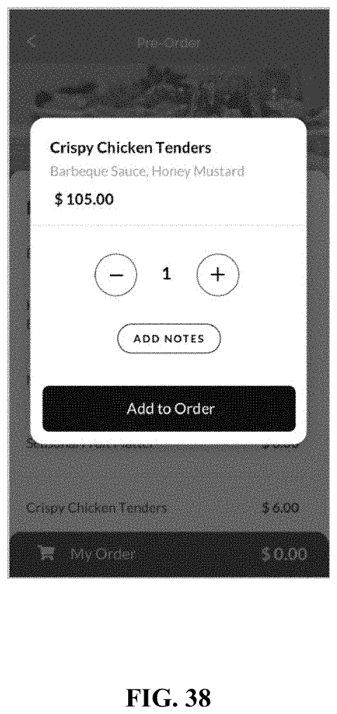

FIG. 38 is an illustration of the user interface of the application, in accordance with some embodiments. Further, the user interface may include the pre-order screen of the “ASAP! Premium service”.

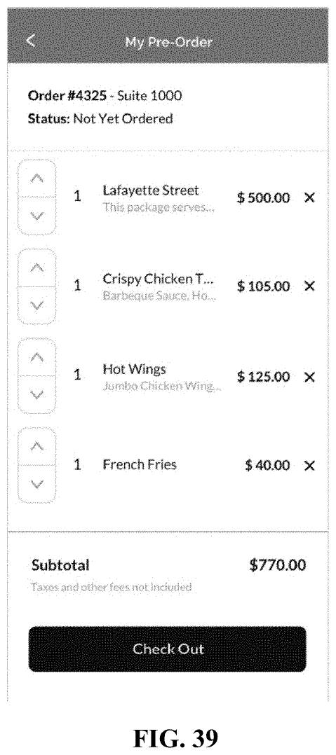

FIG. 39 is an illustration of the user interface of the application, in accordance with some embodiments. Further, the user interface may include a my pre-order screen of the “ASAP! Premium service”.

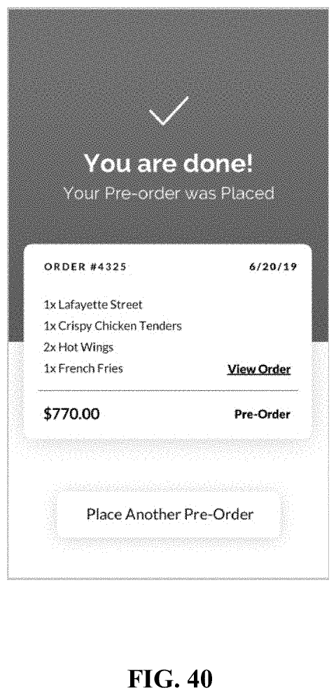

FIG. 40 is an illustration of the user interface of the application, in accordance with some embodiments. Further, the user interface may include confirmation of an order screen of the “ASAP! Premium service”.

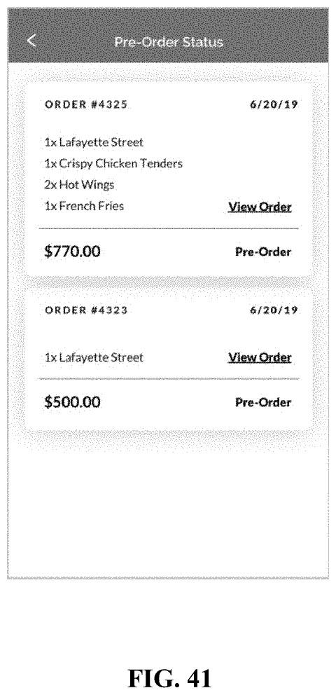

FIG. 41 is an illustration of the user interface of the application, in accordance with some embodiments. Further, the user interface may include a pre-order status careen of the “ASAP! Premium service”.

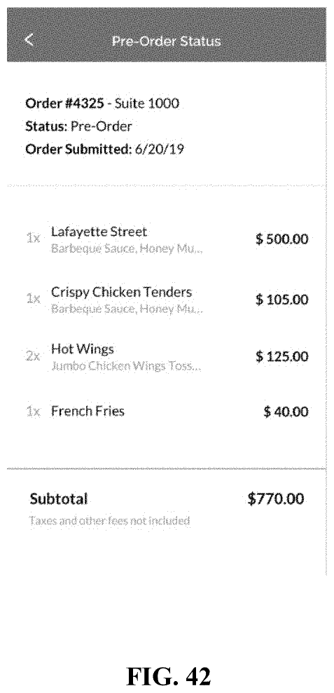

FIG. 42 is an illustration of the user interface of the application, in accordance with some embodiments. Further, the user interface may include the pre-order status screen of the “ASAP! Premium service”.

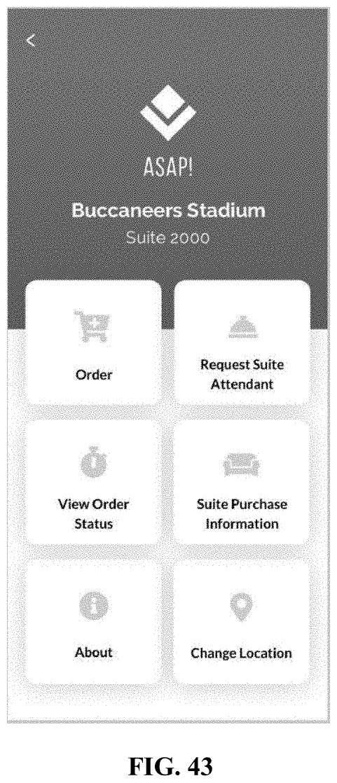

FIG. 43 is an illustration of the user interface of the application, in accordance with some embodiments. Further, the user interface may include a Buccaneers stadium suite 2000 screen of the “ASAP! Premium service”.

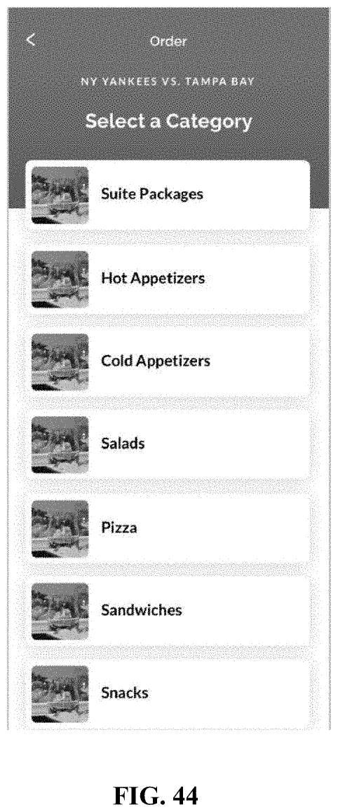

FIG. 44 is an illustration of the user interface of the application, in accordance with some embodiments. Further, the user interface may include an order screen of the “ASAP! Premium service”.

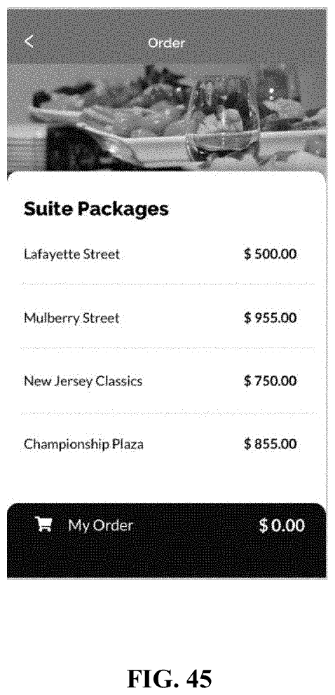

FIG. 45 is an illustration of the user interface of the application, in accordance with some embodiments. Further, the user interface may include the order screen of the “ASAP! Premium service”.

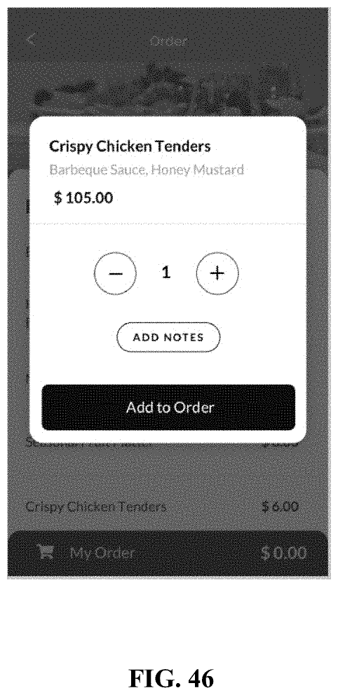

FIG. 46 is an illustration of the user interface of the application, in accordance with some embodiments. Further, the user interface may include the order screen of the “ASAP! Premium service”.

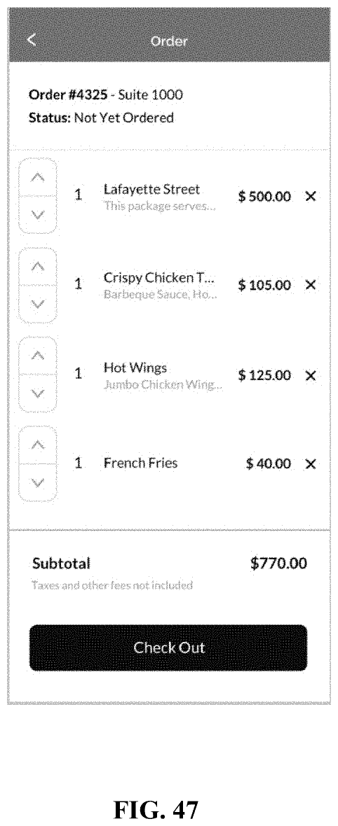

FIG. 47 is an illustration of the user interface of the application, in accordance with some embodiments. Further, the user interface may include the order screen of the “ASAP! Premium service”.

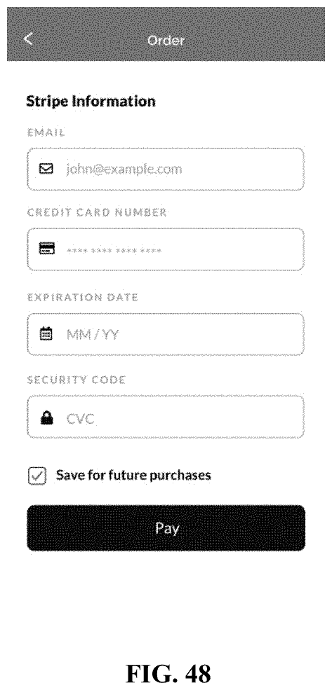

FIG. 48 is an illustration of the user interface of the application, in accordance with some embodiments. Further, the user interface may include the order screen of the “ASAP! Premium service”.

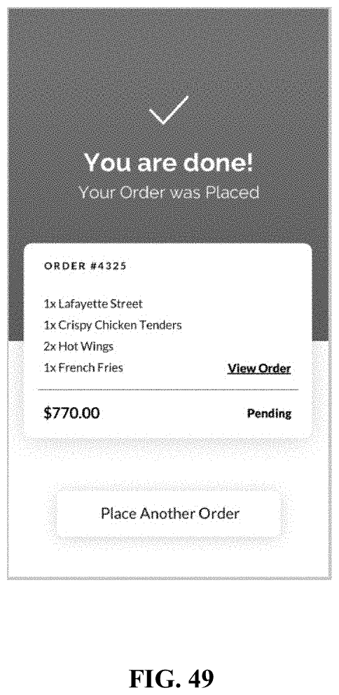

FIG. 49 is an illustration of the user interface of the application, in accordance with some embodiments. Further, the user interface may include a confirmation of an order screen of the “ASAP! Premium service”.

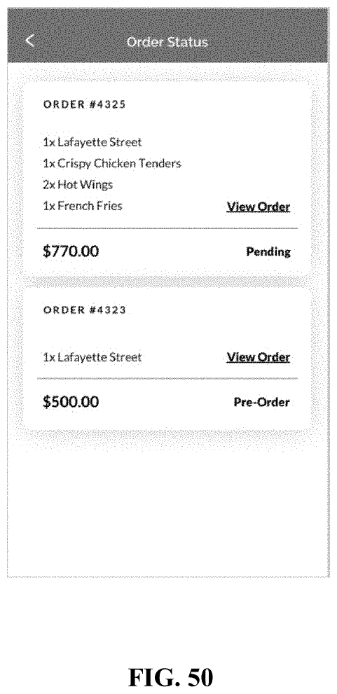

FIG. 50 is an illustration of the user interface of the application, in accordance with some embodiments. Further, the user interface may include an order status screen of the “ASAP! Premium service”.

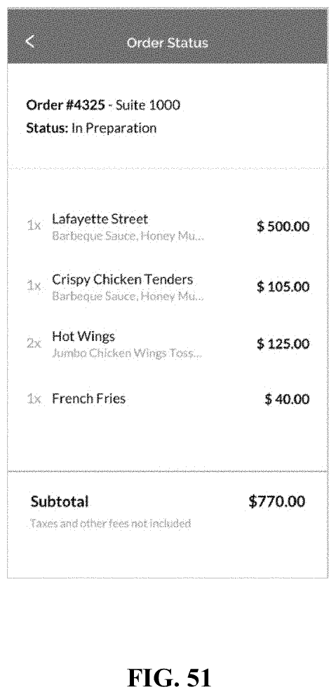

FIG. 51 is an illustration of the user interface of the application, in accordance with some embodiments. Further, the user interface may include the order status screen of the “ASAP! Premium service”.

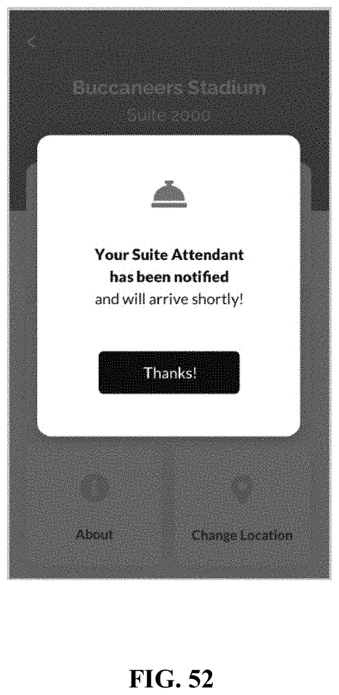

FIG. 52 is an illustration of the user interface of the application, in accordance with some embodiments. Further, the user interface may include a notification for a suite attendant screen of the “ASAP! Premium service”.

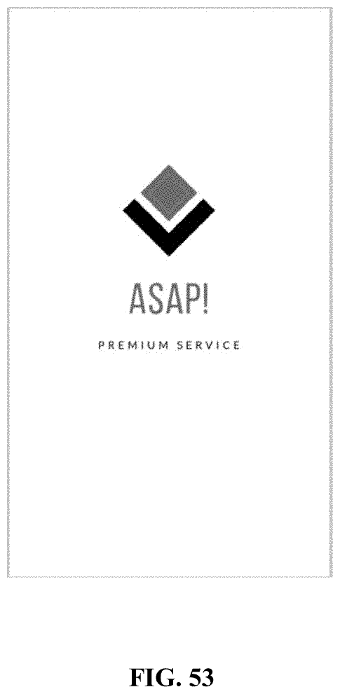

FIG. 53 is an illustration of the user interface of the application, in accordance with some embodiments. Further, the user interface may include a home screen of the “ASAP! Premium service”.

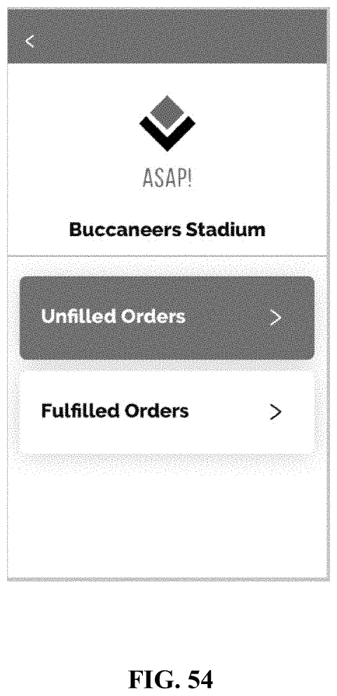

FIG. 54 is an illustration of the user interface of the application, in accordance with some embodiments. Further, the user interface may include a Buccaneers stadium screen of the “ASAP! Premium service”.

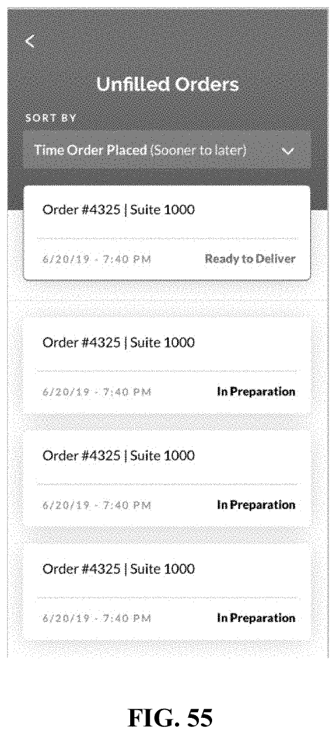

FIG. 55 is an illustration of the user interface of the application, in accordance with some embodiments. Further, the user interface may include an unfilled orders screen of the “ASAP! Premium service”.

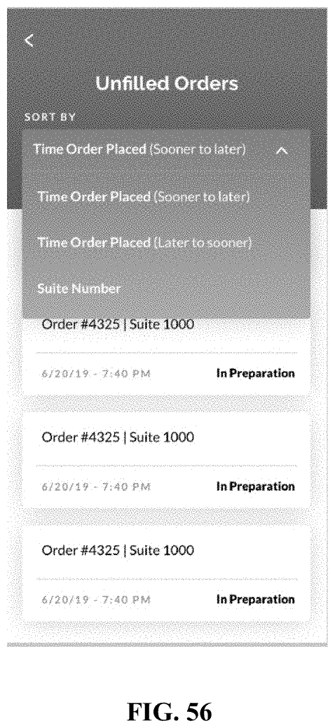

FIG. 56 is an illustration of the user interface of the application, in accordance with some embodiments. Further, the user interface may include the unfilled orders screen of the “ASAP! Premium service”.

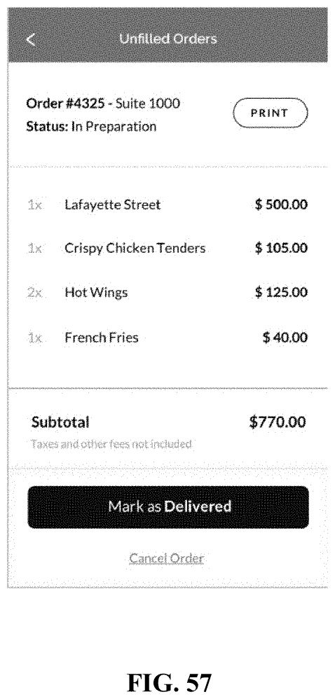

FIG. 57 is an illustration of the user interface of the application, in accordance with some embodiments. Further, the user interface may include the unfilled orders screen of the “ASAP! Premium service”.

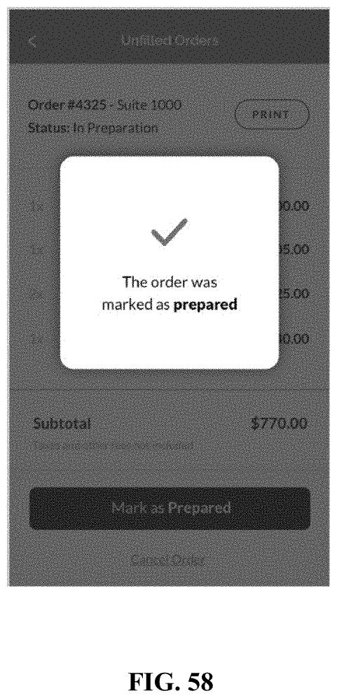

FIG. 58 is an illustration of the user interface of the application, in accordance with some embodiments. Further, the user interface may include the unfilled orders screen of the “ASAP! Premium service”.

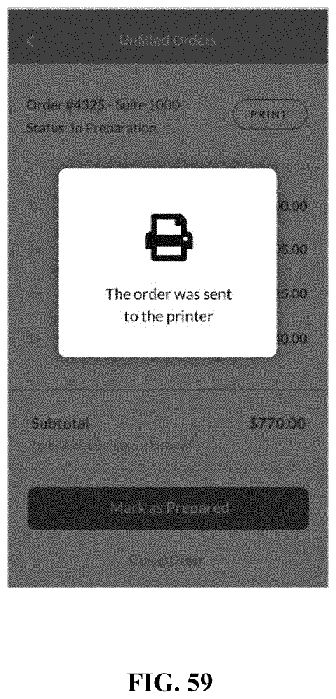

FIG. 59 is an illustration of the user interface of the application, in accordance with some embodiments. Further, the user interface may include the unfilled orders screen of the “ASAP! Premium service”.

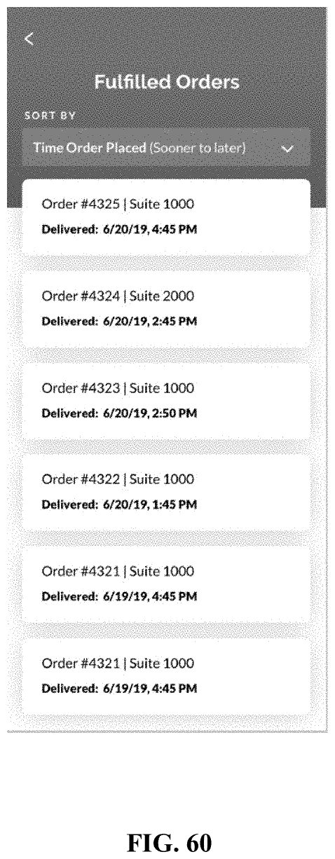

FIG. 60 is an illustration of the user interface of the application, in accordance with some embodiments. Further, the user interface may include a fulfilled orders screen of the “ASAP! Premium service”.

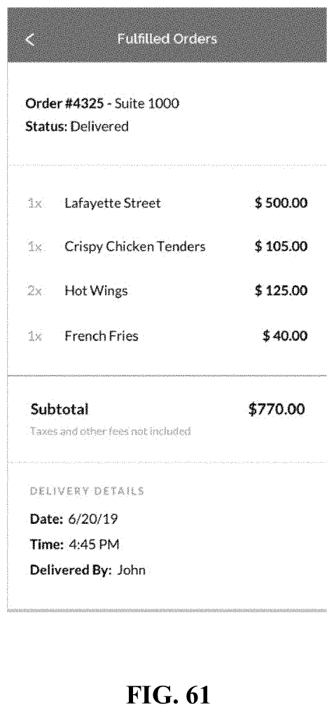

FIG. 61 is an illustration of the user interface of the application, in accordance with some embodiments. Further, the user interface may include the fulfilled orders screen of the “ASAP! Premium service”.

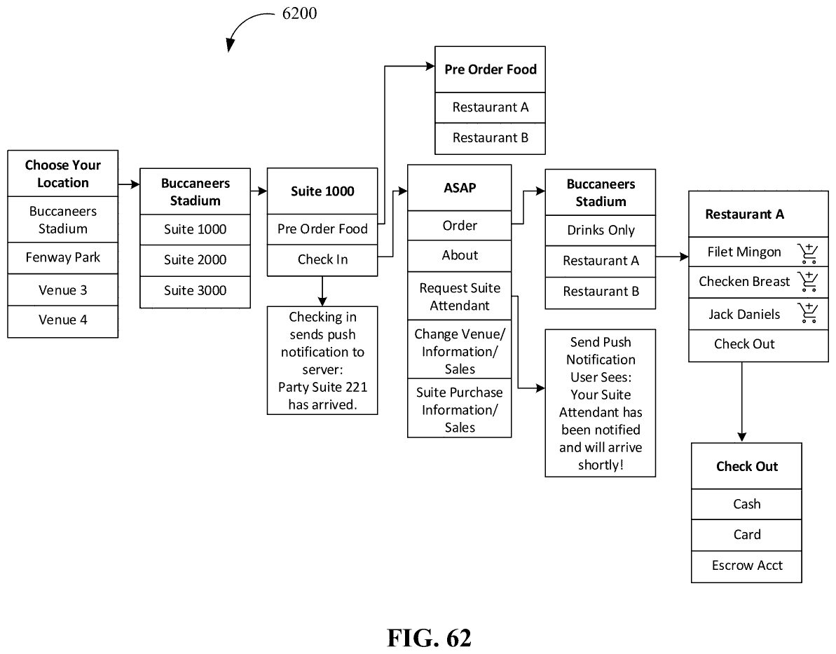

FIG. 62 is a partial flow diagram of a method 6200 for facilitating managing, ordering, and accepting sales of food and beverage, in accordance with some embodiments.

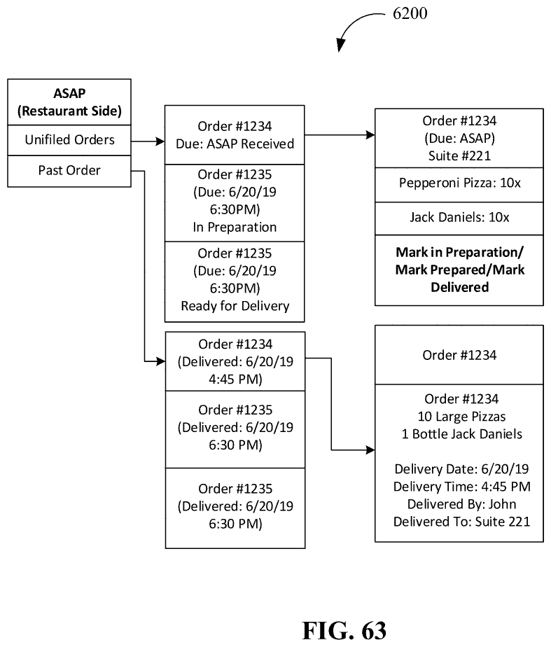

FIG. 63 is a partial flow diagram of the method 6200 for facilitating the managing, the ordering, and the accepting sales of the food and the beverage, in accordance with some embodiments.

With reference to FIG. 30-63, the ASAP! Premium Service may be described. Further, the ASAP! Premium Service, may be a mobile application that pride speed of service and payment system for food and beverage orders to premium service areas of stadiums and arenas. Further, the ASAP! Premium Service comprises a file management engine and a user interface (UI) engine. Further, the ASAP! Premium Service start, stop and manage point of sale services and payments by the user's command. The term ‘engine’ may be used herein to describe collections of programs that are grouped by function. Additionally, the term ‘smart device’ may be used to describe mobile electronic devices that are capable of running the ASAP! Premium Service software and have an interactive screen, which can react to user's commands on the screen. Further, the ASAP! Premium Service may be a program that ensures a user may be able to check-in, notifies the staff of the stadium or arena, and manages the order along with payments. Further, the functionality may be enabled by using the input data given by the user into the ASAP! Premium Service software. Further, the ASAP! Premium Service allows the user to open an account, check in to the stadium or arena, select the suite number, and place a pre-order of the food and beverage that they wish to have. Further, the ASAP! Premium Service allows the user to pay and track the order placed with its progress rate. Further, the ASAP! Premium Service may be used by the staff of the stadium or arena and the arena. Further, the ASAP! Premium Service offers a management version that can be tackled by the managers to see the overall process and the progress rate. Further, the ASAP! Premium Service provides a system that automatically manages the user's need by allowing the user to place an order, request suite attendant, view order status, and much more. Further, a phone running the ASAP! Premium Service system may be always ready to create memorable moments with good service. Further, a first screen of the ASAP! Premium Service may be a welcome screen. The welcome screen allows the user to select their location, particularly a stadium or arena. Moreover, the welcome screen provides the user with options of the stadium or arena present in the chosen location. Further, the user may quickly choose the stadium or arena. Further, a second screen of the ASAP! Premium Service app may be a first selection screen. The first selection screen allows the user to choose a particular suite from the suites that are available in the stadium or arena. The first selection screen may not be limited to suite selection only but can provide other types of selection service as well. Further, a third screen of the ASAP! Premium Service app may be a second selection screen. The second selection screen may be the pre-order or check-in screen. Here, the user can choose between either pre-ordering food and beverage, snacks, and more or the user can check into the user's suite to access all the services available. Further, a fourth screen of the ASAP! Premium Service app may be a third selection screen. The third selection screen may be the place a pre-order or view pre-order screen, the third selection screen allows the user to select whether the user wants to place a pre-order, or the user wants to view the pre-orders already placed. If the user selects the place a pre-order screen, then the ASAP! Premium Service app may direct the user to a fourth selection screen. Further, a fifth screen of the ASAP! Premium Service app may be the fourth selection screen. The fourth selection screen may be the event selection screen. Here, the user selects the event that the user may be attending. The fourth selection screen gives different options for the events that may take place in the previously selected stadium or arena. The fourth selection screen gives information from the date, event name, and the time that the event may take place. The user can select the one that the user may be attending. Further, a sixth screen of the ASAP! Premium Service app may be a fifth selection screen. The fifth selection screen displays a list of categories from which the user can make a pre-order. This gives the user the option of food and beverage categories to choose from, for example, “Suite Packages”, “Hot Appetizers” and more. Further, a seventh screen of the ASAP! Premium Service app may be a sixth selection screen. The sixth selection screen depends on the food and beverage category that was selected by the user on the sixth screen. Furthermore, the sixth selection screen allows the user to pick particular food and beverage items in order to make a pre-order for the event that was previously selected by the user. Further, an eighth screen of the ASAP! Premium Service app may be a seventh selection screen. The seventh selection screen allows the user to review the food and beverage item that was selected in the seventh screen. Further, a ninth screen of the ASAP! Premium Service app may be an eighth selection screen. The eighth selection screen gives a summary of the orders placed and the total amount that the user needs to pay. After the user confirms, the ASAP! Premium Service app shows a confirmation screen saying the order has been placed. Further, the user can also check the status of the pre-order placed through the ASAP! Premium Service app. The ASAP! Premium Service app can also be used by the staff and the management team. The staff can easily and conveniently view the orders placed along with there timings. The ASAP! Premium Service app also allows the staff members to have push notifications on their smart devices. Additionally, the staff members can view the progress of each order placed and the time they need to deliver the service. Furthermore, the ASAP! Premium Service app also notifies the user before the end of the game progresses so that the user can order their services accordingly.

Although the present disclosure has been explained in relation to its preferred embodiment, it is to be understood that many other possible modifications and variations can be made without departing from the spirit and scope of the disclosure.

The following is claimed:

1. A method for facilitating management of services for an individual at an event, the method comprising:
receiving, using a communication device, at least one individual data associated with at least one individual from at least one individual device;
retrieving, using a storage device, at least one event data associated with at least one event, wherein the at least one event data comprises a location of the at least one event and a time of the at least one event;
analyzing, using a processing device, the at least one individual data based on the at least one event data;
determining, using the processing device, at least one time and at least one location associated with at least one service based on the analyzing;
generating, using the processing device, at least one service data based on the determining; and
transmitting, using the communication device, the at least one service data to at least one service provider device associated with at least one service provider, wherein the at least one service provider provides the at least one service to the at least one individual.

2. The method of claim 1, wherein the at least one individual device comprises at least one sensor, wherein the at least one sensor is configured for generating the at least one individual data based on a location of the at least one individual, wherein the determining of the at least one time and the at least one location of the at least one service is based on the analyzing of the at least one individual data.

3. The method of claim 2, wherein the analyzing comprises comparing the location of the at least one individual and the location of the at least one event based on the time of the at least one event, wherein the determining of the at least one time and the at least one location of the at least one service is based on the comparing.

4. The method of claim 2 further comprising:
receiving, using the communication device, at least one second sensor data from at least one second sensor, wherein the at least one second sensor is comprised in the at least one service provider device, wherein the at least one second sensor is configured for generating the at least one second sensor data based on a location of the at least one service provider;
analyzing, using the processing device, the at least one second sensor data based on the at least one individual data;
determining, using the processing device, a proximity between the at least one service provider and the at least one individual based on the analyzing of the at least one second sensor data;
generating, using the processing device, at least one alert based on the determining of the proximity; and
transmitting, using the communication device, the at least one alert to at least one of the at least one individual device and the at least one service provider device.

5. The method of claim 1 further comprising:
receiving, using the communication device, at least one action data associated with the at least one service from the at least one service provider device, wherein the at least one action data comprises at least one action performed by the at least one service provider for providing the at least one service to the at least one individual;
analyzing, using the processing device, the at least one action data based on the at least one event data; and
determining, using the processing device, at least one of a location and a time for performing the at least one action based on the analyzing of the at least one action data, wherein the generating of the at least one service data is based on the determining of the at least one of the location and the time for performing the at least one action.

6. The method of claim 1 further comprising:
receiving, using the communication device, at least one data associated with the at least one service from the at least one service provider device;
analyzing, using the processing device, the at least one data based on the at least one event data;
determining, using the processing device, at least one status of the at least one service based on the analyzing of the at least one data;
generating, using the processing device, at least one status data associated with the at least one service based on the determining of the at least one status; and
transmitting, using the communication device, the at least one status data to the at least one individual device.

7. The method of claim 1 further comprising:
receiving, using the communication device, at least one service indication associated with the at least one service from the at least one individual device;
analyzing, using the processing device, the at least one service indication; and
determining, using the processing device, at least one action associated with the at least one service based on the analyzing of the at least one service indication, wherein the generating of the at least one service data is based on the determining of the at least one action.

8. The method of claim 1 further comprising:
receiving, using the communication device, at least one first data from the at least one service provider device, wherein the at least one first data comprises the at least one service provided by the at least one service provider at the at least one event;
analyzing, using the processing device, the at least one first data based on the at least one individual data;
generating, using the processing device, at least one order associated with the at least one individual based on the analyzing, wherein the at least one service comprises the at least one order; and
transmitting, using the communication device, the at least one order to the at least one service provider device.

9. The method of claim 1 further comprising:
receiving, using the communication device, at least one first sensor data from at least one first sensor, wherein the at least one first sensor is configured for generating the at least one first sensor data based on a presence of the at least one individual in the location of the at least one event at the time of the at least one event;
analyzing, using the processing device, the at least one first sensor data; and
identifying, using the processing device, the at least one individual based on the analyzing of the at least one first sensor data, wherein the determining of the at least one time and the at least one location associated with the at least one service based on the analyzing of the at least one individual information is based on the identifying.

10. The method of claim 1 further comprising:
receiving, using the communication device, at least one individual indication associated with the at least one individual from at least one attendant device associated with at least one attendant;
identifying, using the processing device, the at least one individual based on the at least one individual indication;
receiving, using the communication device, at least one second data from the at least one attendant device; and
modifying, using the processing device, the at least one individual data based on the at least one second data, wherein the analyzing the at least one individual data based on the at least one event data is based on the modifying.

11. A system for facilitating management of services for an individual at an event, the system comprising:
a communication device configured for:
receiving at least one individual data associated with at least one individual from at least one individual device; and
transmitting at least one service data to at least one service provider device associated with at least one service provider, wherein the at least one service provider provides the at least one service to the at least one individual.
a storage device configured for retrieving at least one event data associated with at least one event, wherein the at least one event data comprises a location of the at least one event and a time of the at least one event; and
a processing device communicatively coupled with the communication device and the storage device, wherein the processing device is configured for
analyzing the at least one individual data based on the at least one event data;
determining at least one time and at least one location associated with at least one service based on the analyzing; and
generating at least one service data based on the determining.

12. The system of claim 11, wherein the at least one individual device comprises at least one sensor, wherein the at least one sensor is configured for generating the at least one individual data based on a location of the at least one individual, wherein the determining of the at least one time and the at least one location of the at least one service is based on the analyzing of the at least one individual data.

13. The system of claim 12, wherein the analyzing comprises comparing the location of the at least one individual and the location of the at least one event based on the time of the at least one event, wherein the determining of the at least one time and the at least one location of the at least one service is based on the comparing.

14. The system of claim 12, wherein the communication device is further configured for:
receiving at least one second sensor data from at least one second sensor, wherein the at least one second sensor is comprised in the at least one service provider device, wherein the at least one second sensor is configured for generating the at least one second sensor data based on a location of the at least one service provider; and
transmitting at least one alert to at least one of the at least one individual device and the at least one service provider device, wherein the processing device is further configured for:
analyzing the at least one second sensor data based on the at least one individual data;
determining a proximity between the at least one service provider and the at least one individual based on the analyzing of the at least one second sensor data; and
generating the at least one alert based on the determining of the proximity.

15. The system of claim 11, wherein the communication device is further configured for receiving at least one action data associated with the at least one service from the at least one service provider device, wherein the at least one action data comprises at least one action performed by the at least one service provider for providing the at least one service to the at least one individual, wherein the processing device is further configured for analyzing the at least one action data based on the at least one event data; and
determining at least one of a location and a time for performing the at least one action based on the analyzing of the at least one action data, wherein the generating of the at least one service data is based on the determining of the at least one of the location and the time for performing the at least one action.

16. The system of claim 11, wherein the communication device is further configured for:
receiving at least one data associated with the at least one service from the at least one service provider device; and
transmitting at least one status data to the at least one individual device, wherein the processing device is further configured for analyzing the at least one data based on the at least one event data;
determining at least one status of the at least one service based on the analyzing of the at least one data; and
generating the at least one status data associated with the at least one service based on the determining of the at least one status.

17. The system of claim 11, wherein the communication device is further configured for receiving at least one service indication associated with the at least one service from the at least one individual device, wherein the processing device is further configured for:
analyzing the at least one service indication; and
determining at least one action associated with the at least one service based on the analyzing of the at least one service indication, wherein the generating of the at least one service data is based on the determining of the at least one action.

18. The system of claim 11, wherein the communication device is further configured for:
receiving at least one first data from the at least one service provider device, wherein the at least one first data comprises the at least one service provided by the at least one service provider at the at least one event; and
transmitting at least one order to the at least one service provider device, wherein the processing device is further configured for:
analyzing the at least one first data based on the at least one individual data; and
generating at least one order associated with the at least one individual based on the analyzing, wherein the at least one service comprises the at least one order.

19. The system of claim 11, wherein the communication device is further configured for receiving at least one first sensor data from at least one first sensor, wherein the at least one first sensor is configured for generating the at least one first sensor data based on a presence of the at least one individual in the location of the at least one event at the time of the at least one event, wherein the processing device is further configured for:
analyzing the at least one first sensor data; and
identifying the at least one individual based on the analyzing of the at least one first sensor data, wherein the determining of the at least one time and the at least one location associated with the at least one service based on the analyzing of the at least one individual information is based on the identifying.

20. The system of claim 11, wherein the communication device is further configured for:
receiving at least one individual indication associated with the at least one individual from at least one attendant device associated with at least one attendant;
receiving at least one second data from the at least one attendant device, wherein the processing device is further configured for:
identifying the at least one individual based on the at least one individual indication; and
modifying the at least one individual data based on the at least one second data, wherein the analyzing the at least one individual data based on the at least one event data is based on the modifying.
